(19) United States
(12) Patent Application Publication
(10) Pub. No.: US 2015/0082879 A1
(43) Pub. Date: Mar. 26, 2015

(54) FLUID FLOW SENSOR WITH REVERSE-INSTALLATION DETECTION

(71) Applicant: Therm-O-Disc, Incorporated, Mansfield, OH (US)

(72) Inventors: Timothy Graff, Mansfield, OH (US); Bernd D. Zimmermann, Ashland, OH (US)

(73) Assignee: Therm-O-Disc, Incorporated, Mansfield, OH (US)

(21) Appl. No.: 14/037,902

(22) Filed: Sep. 26, 2013

(51) Int. Cl. G01F 1/69

(52) U.S. Cl. CPC G01F 1/69
USPC 73/204.25

(57) ABSTRACT

A thermo-anemometer-type fluid flow sensor and a method associated with quickly determining whether the sensor has been installed in an improper orientation relative to the direction of fluid flowing through a system. The flow sensor comprises a detection module adapted to change condition in response to the direction of fluid flowing through the system. A control module is connected to the probe and is capable of determining the installation orientation of a probe of the sensor. An I/O module is connected to the control module to provide a means for communicating the output of the control module to another device and/or user.

### FIELD

The present disclosure relates to an improved fluid flow sensor and a method associated with quickly determining whether the sensor has been installed in an improper orientation relative to the direction of fluid flowing through a system.

### BACKGROUND

This section provides background information related to the present disclosure and is not necessarily prior art.

The use of fluid flow sensors in household and industrial fluid delivery and/or fluid monitoring systems is common. For example, a fluid flow sensor may be installed in a household dishwasher to monitor and help control the volume of water flowing into the dishwasher to circumvent a potential under-fill or over-fill condition from occurring.

In a typical fluid system, generally, fluid flows through a supply hose in a single direction (i.e., either in a left to right direction, or in a right to left direction). A fluid flow sensor can generally connect to the supply hose in either orientation relative to the direction of fluid flowing through the hose. Accordingly, depending on the orientation that the sensor is connected to the hose dictates whether fluid will flow through the sensor in a left to right direction, or in a right to left direction. However, for the fluid flow sensor to function properly, the sensor must be installed correctly; that is, the sensor must be connected to the hose in proper orientation relative to the direction of fluid flowing through the hose. A sensor that has been installed in an improper orientation relative to the direction of fluid flow can, for example, fail to accurately monitor and control the volume of fluid passing through the system.

Improper orientation, or reverse-installation, can occur at the assembly facility where the sensor is first connected to the fluid system and/or in the field during sensor service or replacement. Unfortunately, there currently lacks a fluid flow sensor and a method associated with quickly determining whether the sensor has been installed in an improper orientation relative to the direction of fluid flowing through a system.

Fluid flow sensors and methods associated with detecting the presence of fluid in a fluid system and determining the rate of fluid flow through a system are generally known. For example, a sensor for realizing whether a threshold fluid level has been attained in a system is shown and described in U.S. Pat. No. 6,862,932, entitled “Liquid Level Sensor,” issued Mar. 8, 2005 and owned by Therm-O-Disc, Incorporated, the assignee of the present patent application, the disclosure of which is hereby incorporated by reference. A sensor for realizing the rate of fluid flow through a system is shown and described in U.S. Pat. No. 7,333,899, entitled “Fluid Flow Rate Sensor and Method of Operation,” issued Feb. 19, 2008 and in U.S. Pat. No. 7,685,875, entitled “Fluid Flow Rate Sensor and Method of Operation,” issued Mar. 30, 2010, both owned by Therm-O-Disc, Incorporated, the assignee of the present patent application, the disclosures of which are hereby incorporated by reference.

### SUMMARY

This section provides a general summary of the disclosure, and is not a comprehensive disclosure of its full scope or all of its features.

A fluid flow sensor and a method associated with quickly determining whether the sensor has been installed in an improper orientation relative to the direction of fluid flowing through a system is disclosed.

In one form, the disclosure provides a fluid flow sensor comprising a probe with a detection module adapted to change condition in response to a direction of flow of fluid through a system. The detection module comprises a a first heating circuit having at least one resistor heater, a second heating circuit having at least one resistor heater, a fluid flow rate detection circuit, and a reverse-installation detection circuit having at least one negative temperature coefficient thermistor. The negative temperature coefficient thermistor of the reverse-installation detection circuit is adapted to provide a voltage that varies in response to a change in temperature.

The fluid flow sensor further comprises a control module electrically connected to the probe that monitors the condition of the detection module and generates an output that is indicative of the direction of flow of fluid. The fluid flow sensor also comprises an I/O module connected to the control module to communicate the output of the control module to another device or a user.

In another form, the present disclosure provides a fluid flow sensor comprising a detection module having a first heating circuit, a second heating circuit, a fluid flow rate detection circuit and a means for determining a direction of flow of fluid through a system.

In yet another form, the present disclosure provides a fluid flow sensor for detecting the direction of flow of fluid through a system comprising the steps of measuring a temperature of a fifth negative temperature coefficient thermistor, applying a voltage to a second resistor heater to generate heat that can be transferred to the fifth negative temperature coefficient thermistor, measuring a temperature of the fifth negative temperature coefficient thermistor, calculating a change in temperature of the fifth negative temperature coefficient thermistor, determining a direction of flow of fluid through the system from the change in temperature of the fifth negative temperature coefficient thermistor, and generating an output that is indicative of the direction of flow of fluid through the system.

Further areas of applicability will become apparent from the description provided herein. The description and specific examples in this summary are intended for purposes of illustration only and are not intended to limit the scope of the present disclosure.

### DRAWINGS

The present disclosure will become more fully understood from the detailed description and the accompanying drawings, wherein:

FIG. 1 is a schematic block diagram of a fluid flow sensor according to the disclosure;

FIG. 2 is a front view of an exemplary probe, shown in partial cross-section, for use with the fluid flow sensor according to the disclosure;

FIG. 3 is an end view of the probe of FIG. 2;

FIG. 4 is a circuit schematic for a representative detection module for use with the probe of FIG. 2;

FIGS. 5A and 5B are representative schematic block diagrams of the detection module of FIG. 4 for use with the probe of FIG. 2;

FIG. 6 is a flow chart describing the operation of the fluid flow sensor according to the disclosure;

FIG. 7A shows a computational fluid dynamic (CFD) model of fluid flowing about the detection module the probe of FIG. 2 when the probe is installed in desired, forward orientation relative to the direction of fluid flow; and

FIG. 7B shows a computational fluid dynamic (CFD) model of fluid flowing about the detection module of the probe of FIG. 2 when the probe is installed in undesired, reverse orientation relative to the direction of fluid flow.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. The example embodiments will now be described more fully with reference to the accompanying drawings.

The present disclosure provides a fluid flow sensor and method associated with quickly determining whether the sensor has been installed in an improper orientation relative to the direction of fluid flowing through a system. By way of example only, it is presently contemplated that the fluid flow sensor of the disclosure can be incorporated into a household dishwasher to monitor water flow therethrough.

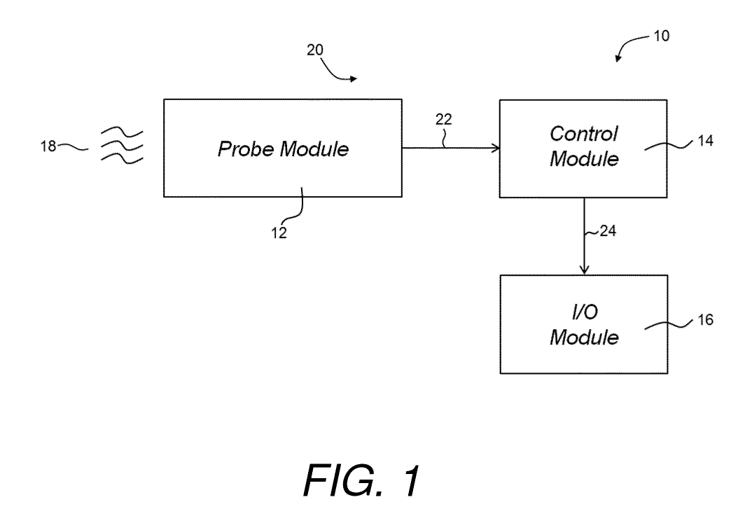

FIG. 1 generally shows the major components of the fluid flow sensor 10. The sensor 10 generally includes a probe module 12, a control module 14 in communication with the probe module 12, and an input/output (I/O) module 16 in communication with the control module 14. As used throughout this description, the term “module” refers to an application specific integrated circuit (ASIC), an electronic circuit, a processor (shared, dedicated, or group) and memory that executes one or more software or firmware programs, a combinational logic circuit, and/or other suitable components that provide the described functionality.

The sensor 10 is of the thermo-anemometer-type and contains no moving parts. The probe 12 is typically disposed in a fluid environment 20. The sensor can be used to determine the flow rate of a fluid 18 and the direction of fluid flow 18. As described further herein, the sensor 10 can quickly determine whether the probe 12 is installed in an improper or reverse orientation relative to the direction of fluid flow 18.

When the probe 12 is subjected to fluid flow 18, the probe 12 experiences a change in condition represented by a signal 22 (e.g., a voltage). The control module 14 continuously monitors the signal 22. According to one aspect of the disclosure, the control module processes the signal 22 and generates an output 24 that is indicative of the installation orientation of the probe 12 relative to the direction of the flow of fluid 18 through the probe. In another aspect of the disclosure, the control module processes the signal 22 and generates an output 24 that is indicative of the flow rate for the fluid 18. The I/O module 16 provides a means by which the sensor 10 can communicate the output 24 to other devices(s) or a user.

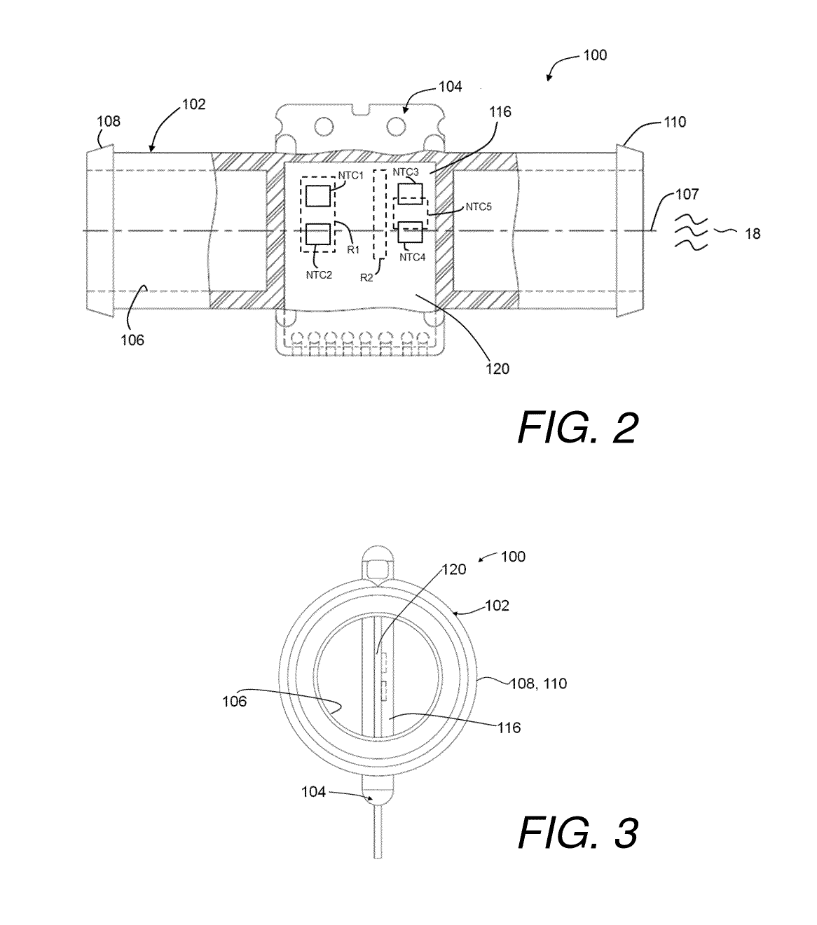

An embodiment of a probe 100 for use in the sensor 10 is shown in FIGS. 2 and 3. The probe 100 generally comprises a body 102 and a detection module 104. The body 102, as shown, is a generally cylindrically shaped tubular member having a passageway 106 extending throughout its entire length along a longitudinal axis 107. Annular flanges 108, 110 may be located at opposite ends of the body 102 to facilitate connection of the probe 100 to a fluid delivery source, such as, for example, a flexible water supply hose (not shown) of a household dishwasher (not shown).

The probe 100 can generally connect to the supply hose in either orientation relative to the direction of fluid flowing through the hose. Accordingly, depending on the orientation that the probe 100 is connected to the hose dictates whether fluid will flow 18 through the passageway 106 in a left to right direction, or in a right to left direction. As discussed above, because the sensor 10 may not function properly when fluid flows 18 through the passageway 106 in one direction versus the other, it is desirable for the sensor 10 to quickly determine if the probe 100 has been installed in an improper or reverse orientation relative to the direction of fluid flow 18.

Located intermediate the annular flanges 108, 110 is a housing 116. The housing 116 extends through the body 102 in a direction generally perpendicular to the longitudinal axis 107, and is disposed within the passageway 106. The shape of the housing 116 is designed to promote laminar fluid flow 18 through the passageway 106 and across the surface of the housing 116. The detection module 104 is received within the housing 116 such that the housing 116 encapsulates a portion of the detection module 104 and protects it from physical contact with the fluid 18. The housing 116 is, however, capable of conducting thermal energy between the fluid 18 and the detection module 104.

Both the body 102 and the housing 116 are preferably manufactured from a thermally conductive polymer, such as, for example, polypropylene, polyvinyl chloride (PVC), polyacetylene, polyparaphenylene, polypyrrole, and polyaniline. Ceramic and/or glass fillers mixed in with these base polymers have been shown to greatly enhance the material's thermal conductivity. One such material is known under the trade designation Konduit MT-210-14 and is available from GE/LNP.

A representative detection module 104 can be understood with reference to FIGS. 2, 4, 5A and 5B. The detection module 104 is preferably highly thermally conductive and has a low thermal mass. The detection module 104 comprises a first heating circuit 112, a second heating circuit 113, a reverse-installation detection circuit 114, and a fluid flow rate detection circuit 115. The first heating circuit 112, second heating circuit 113, reverse-installation detection circuit 114, and fluid flow rate detection circuit 115 can be deposited on a thermally conductive, glass-epoxy printed circuit board (PCB) substrate 120.

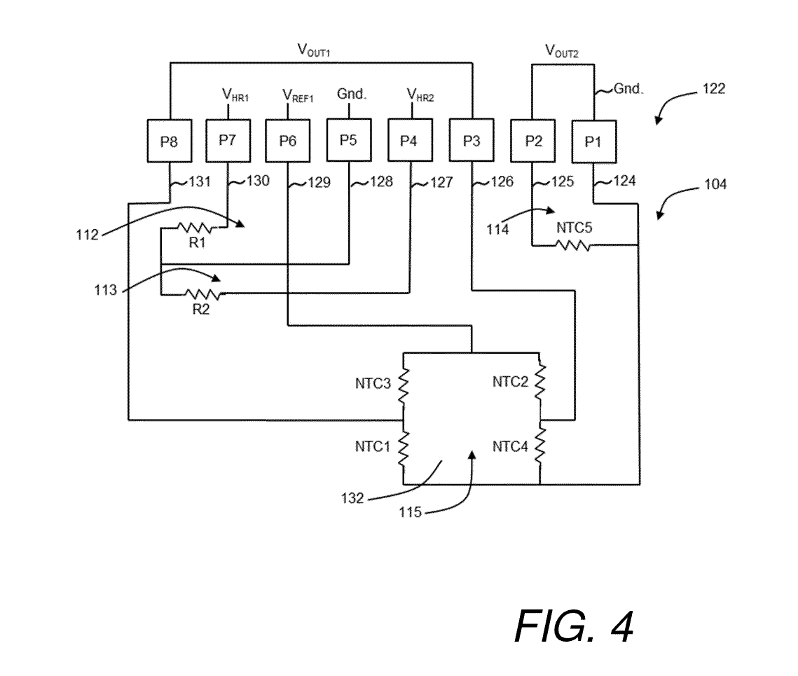

Referring to FIG. 4, the first heating circuit 112 comprises a resistor heater R1. Resistor heater R1 is adapted to function as a primary heater and is operable to provide approximately 1.5 watts of power. The second heating circuit 113 comprises a resistor heater R2. Resistor heater R2 is adapted to function as a secondary heater and is operable to provide approximately 500 milliwatts of power. Resistor heaters R1, R2 can be arranged in parallel.

The reverse-installation detection circuit 114 comprises a negative temperature coefficient (NTC) thermistor NTC5, which is arranged to operate as a temperature sensing thermistor.

The fluid flow rate detection circuit 115 comprises a plurality of negative temperature coefficient (NTC) thermistors NTC1, NTC2, NTC3, NTC4 that together form a 4-wire bridge circuit 132. Thermistor NTC1 is coupled in series with thermistor NTC3 to form one leg of the bridge 132 and thermistor NTC2 is coupled in series with thermistor NTC4 to form the other leg of the bridge 132. Together, thermistors NTC1, NTC3 are coupled in parallel with thermistors NTC2, NTC4.

The circuit schematic 122 of FIG. 4 also shows a plurality of traces 124, 125, 126, 127, 128, 129, 130, 131 that lead to a plurality of pin connectors P1, P2, P3, P4, P5, P6, P7, P8, respectively. The first heating circuit 112 includes traces 128, 130 and pins P5, P7. Trace 128 terminates at pin P5, which is connected to ground. Trace 130 terminates at pin P7, where a voltage V_{HR1} is applied to turn ON and energize the resistor heater R1.

The second heating circuit 113 includes traces 127, 128 and pins P4, P5. Trace 127 terminates at pin P4, where a voltage V_{HR2} is applied to turn ON and energize resistor heater R2. As described above, trace 128 terminates at pin P5, which is connected to ground.

The reverse-installation detection circuit 114 includes traces 124, 125 and pins P1, P2. An output voltage V_{OUT2}, which is calibrated to represent a temperature of thermistor NTC5 can be read at pins P1, P2.

The fluid flow rate detection circuit 115 includes traces 124, 126, 129, 131 and pins P1, P3, P6, P8. Trace 124 terminates at pin P1, which is connected to ground. Trace 129 terminates at pin P6, where a reference voltage V_{REF1} is applied. Traces 126, 131 are coupled to opposite legs of the bridge 132 and terminate at pins P3, P8, respectively. An output voltage V_{OUT1}, which is calibrated to represent a temperature difference across the bridge 132 and between thermistors NTC1, NTC3 and NTC2, NTC4, can be read at pins P3, P8.

Thermistors NTC1, NTC2, NTC3, NTC4 are generally disposed on side A of the substrate 120. Thermistors NTC1, NTC2 are located generally proximate a first, downstream edge 136 of the substrate 120. Thermistors NTC3, NTC4 are located generally proximate a second, upstream edge 138 of the substrate 120, opposite the first edge 136. Thermistors NTC1, NTC3 are generally located above thermistors NTC2, NTC4.

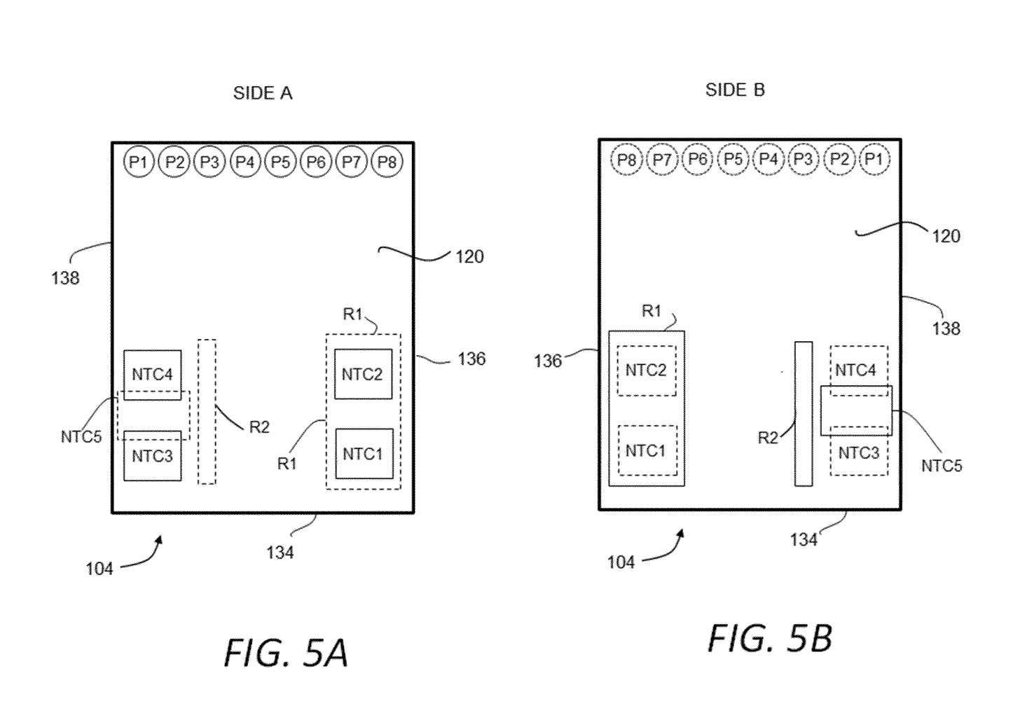

Thermistor NTC5 and resistor heaters R1, R2 are generally disposed on side B of the substrate 120. It is understood, however, that resistor heater R2 can be relocated to side A of the substrate 120. As shown in FIGS. 2, 5A and 5B, thermistor NTC5 is located on the substrate 120 generally proximate second edge 138. Resistor heater R1 is located on the substrate 120 generally proximate the first edge 136 and opposite to thermistors NTC1, NTC2 that are disposed on side A of the substrate 120.

Resistor heater R2 is generally located between thermistor NTC5 and resistor heater R1, and can be positioned closer to the second edge 138 of the substrate 120, and relatively proximate to thermistor NTC5.

As discussed below, heat energy from resistor heater R1 is generally conducted to thermistors NTC1, NTC2. Heat energy from resistor heater R1 is generally not, however, conducted to thermistors NTC3, NTC4, NTC5.

Thermistors NTC3, NTC4, disposed on side A of the substrate 120, are positioned generally opposite thermistor NTC5 and near resistor heater R2, both of which are disposed on side B of the substrate 120. As will be described further below, heat energy from resistor heater R2 can be conducted to thermistor NTC5 depending on the direction of fluid flow 18 through the passageway 106 of the probe 100. Heat energy from resistor heater R2 is not, however, conducted to thermistors NTC1, NTC2, NTC3, NTC4.

The detection module 104 disposed on the PCB substrate 120 is generally received within the housing 116 such that it is generally perpendicular to the direction of fluid flow 18 through the passageway 106. With particular reference to FIG. 2, resistor heaters R1, R2 and thermistors NTC1, NTC2, NTC3, NTC4, NTC5 are located within the housing 116 and lie within the passageway 106 of the body 102. All of the pin connectors P1, P2, P3, P4, P5, P6, P7, P8, however, extend outward from the housing 116.

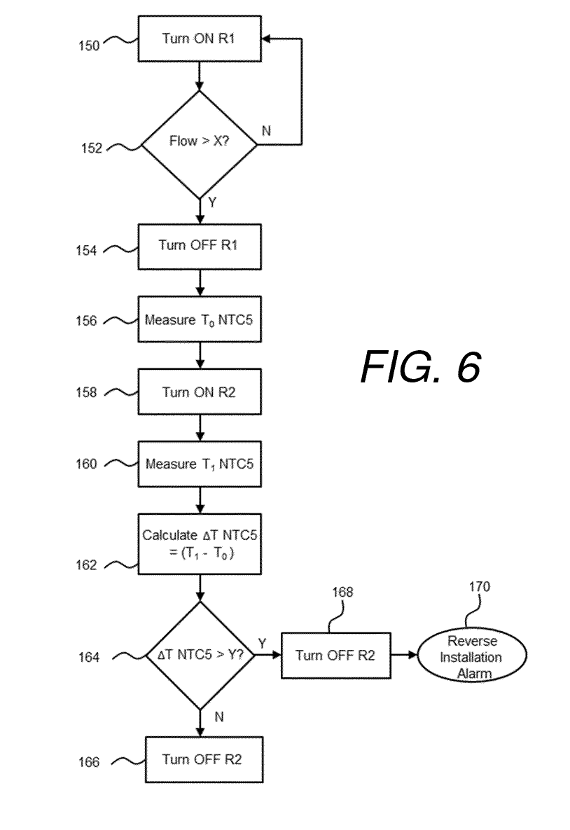

The sensor 10 of the present disclosure can generally operate in two modes: a fluid flow rate detection mode and a reverse installation detection mode. Of course, it will be appreciated by persons skilled in the art that the reverse installation detection mode can also serve to determine the direction of fluid flow. FIG. 6 is a flow chart describing an exemplary method employed by the sensor 10 to enable the sensor 10 to quickly determine whether the probe 100 has been installed in an improper or reverse orientation relative to the flow direction F of the fluid 18.

First, the rate of fluid flow 18 through the probe 100 is determined. Preferably, a minimum threshold fluid flow rate through the probe 100 in the range of 1 to 5 liters per minute (LPM), should be present before the sensor 10 operates to detect the whether the probe 100 has been installed in a reverse orientation. If the rate of the fluid flow 18 through the probe 100 is below the minimum threshold fluid flow rate, the sensor's 10 ability to accurately determine whether the probe 100 has been properly installed relative to the direction F of flow of the fluid 18 can be compromised.

To determine the rate of fluid flow 18 through the environment 20, at 150, the control module 14 applies a voltage V_{HR1} to pin 7 to turn ON and energize resistor heater R1. As a result, the temperature (Tᵢ) of thermistors NTC1, NTC2 increases. The temperature of thermistors NTC1, NTC2 is determined from the output voltage V_{OUT1}, which is read at pins P3, P8 by the control module 14, as described and taught in U.S. Pat. No. 7,333,899, entitled “Fluid Flow Rate Sensor and Method of Operation,” issued Feb. 19, 2008, which is hereby incorporated by reference. The temperature of thermistors NTC3, NTC4, NTC5 is not, however, affected by turning ON and energizing resistor heater R1 at 150. The reference voltage V_{REF1} is applied to the fluid flow rate detection circuit 115.

As fluid flows 18 through the passageway 106, passes over and around the housing 116 and consequently flows over the portion of the detection module 104 enclosed within the housing 116, heat energy is transferred from thermistors NTC1, NTC2 to the fluid 18. Accordingly, the temperature (Tᵢ) of thermistors NTC1, NTC2 changes over time (t). The temperature (Tᵢ) of thermistors NTC1, NTC2 and the output voltage V_{OUT1} is sampled by the control module 14 at discrete time intervals (e.g., 100 msec).

The use of four thermistors NTC1, NTC2, NTC3, NTC4 in the fluid flow rate detection circuit 115 and their physical arrangement in the passageway 106 of the body 102 provides significant advantages. One significant advantage is that the output voltage V_{OUT1} automatically compensates for any ambient temperature changes, i.e., changes in the temperature of the fluid 18. This is important because if significant and/or rapid changes in the fluid 18 temperature occurs, the output 24 of the sensor 10 could be distorted, thereby causing the sensor 10 to generate inaccurate results, as described and taught in U.S. Pat. No. 7,333,899, entitled “Fluid Flow Rate Sensor and Method of Operation,” issued Feb. 19, 2008.

Once the control module 14 samples the output voltage V_{OUT1} at discrete time intervals (e.g., 100 msec), the control module 14 then determines the rate of change of the temperature (Tᵢ) over time (t) (i.e., it calculates dTᵢ/dt). This process is repeated for a predetermined number of iterations (e.g., 10). Then, the smallest value of dTᵢ/dt can be correlated to a fluid flow rate. At 152, the control module compares the rate of fluid flow 18 to the minimum threshold fluid flow rate to determine whether to proceed to the next step.

As discussed above, if the rate of fluid flow 18 through the passageway 106 is below the minimum threshold fluid flow rate, the sensor's 10 ability to accurately detect the orientation of the probe 100 relative to the direction of fluid flow 18 can be diminished. Consequently, preferably, the process will not proceed until the rate of fluid flow 18 through the passageway 106 is at or above the minimum threshold fluid flow rate.

If the rate of fluid flowing 18 through the passageway 106 is above the minimum threshold fluid flow rate, at 154, resistor heater R1 is turned OFF and the process proceeds. At 156, the control module 14 reads V_{OUT2} at P1, P2 and records a temperature T₀ of thermistor NTC5. At 158, the control module 14 then applies a voltage V_{HR2} to pin P4, to turn ON and energize resistor heater R2. As fluid 18 flows through the passageway 106 and passes over and around the housing 116 and consequently over the portion of the detection module 104 that is enclosed within the housing 116, heat energy is transferred from resistor heater R2 to the fluid 18. The fluid 18, therefore, heats as it passes the resistor heater R2 and its temperature rises accordingly.

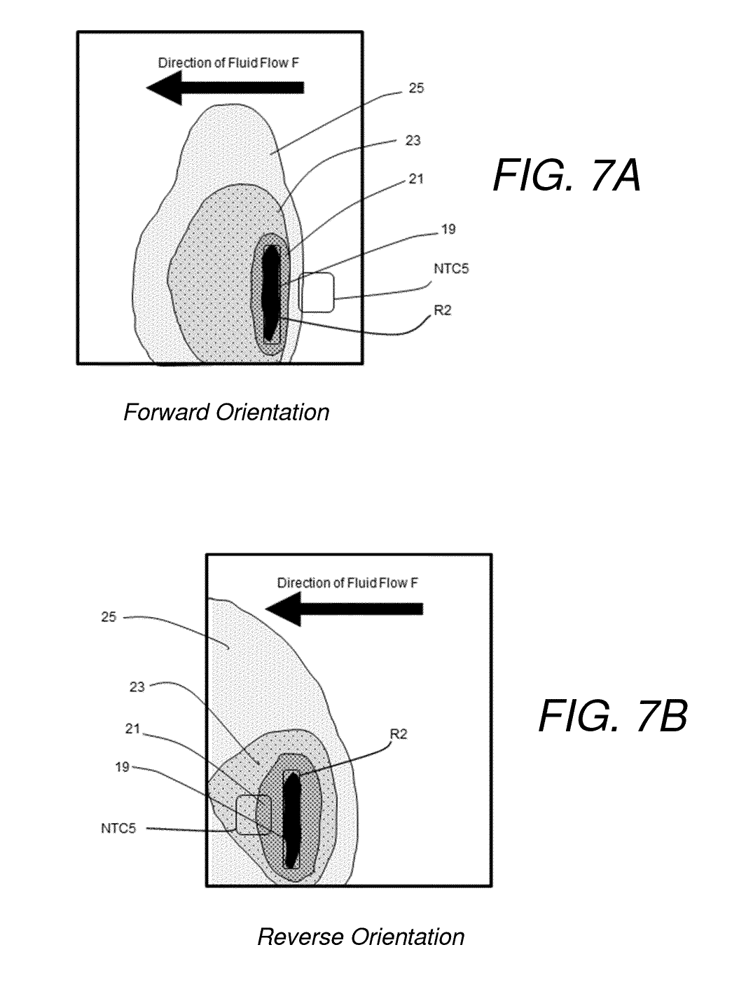

FIGS. 7A and 7B illustrate computational fluid dynamic (CFD) models showing the temperature gradients of the heated fluid 18 flowing past the detection module 104 of the probe 100 when the resistor heater R2 is ON and energized. Specifically, FIG. 7A shows the temperature gradients of the fluid flowing past the detection module 104 when the probe 100 is installed in a desired, forward orientation relative to the direction F of fluid flow and FIG. 7B shows the temperature gradients of the fluid flowing past the detection module 104 when the probe 100 is installed in a undesired, reverse orientation relative to the direction F of fluid flow. As shown in the models of FIGS. 7A and 7B, the heated fluid can be represented with a plurality of temperature gradients 19, 21, 23 and 25, where the highest temperature, represented at gradient 19, is closest to the resistor heater R2, and decreasingly relatively lower temperatures are represented at gradients 21, 23, and 25, respectively, as the fluid 18 moves further away from the resistor heater R2.

Referring to FIG. 7A, the probe 100 is installed in a desired, forward orientation relative to the direction F of fluid flow. In this installation configuration, thermistor NTC5 is located upstream of the resistor heater R2. Consequently, when resistor heater R2 is turned ON and energized at 158, and heat is conducted from resistor heater R2 to the fluid 18, the heated fluid 19, 21, 23 and 25 flows away from thermistor NTC5. As such, heat energy from the heated fluid 19, 21, 23, 25 is not conducted to thermistor NTC5 and the temperature T₁ of thermistor NTC5 does not increase due to resistor heater R2 being turned ON.

Conversely, with reference to FIG. 7B, when the probe 100 is installed in an undesired, reverse orientation relative to the direction F of fluid flow, thermistor NTC5 is located downstream of the resistor heater R2. In this reverse-orientation installation, the heated fluid 19, 21, 23, 25 generated by resistor heater R2 flows toward and across thermistor NTC5. The heat energy from the heated fluid 19, 21, 23, 25, therefore, is conducted to thermistor NTC5, thereby causing the temperature T₁ of thermistor NTC5 to increase. An increase in temperature of thermistor NTC5 can, therefore, be correlated to the installation orientation of the probe 100 relative to the direction F of fluid flow.

Referring back to FIG. 6, at 160, the control module 14 monitors V_{OUT2} at P1, P2 and records the temperature T₁ of thermistor NTC5. At 162, the control module 14 calculates a temperature difference ΔT of thermistor NTC5, from temperature measurements taken at 160 and 156 (ΔT=T₁−T₀). A temperature difference ΔT is then compared to a predetermined threshold value. The threshold value can range from about 0.1° C. to about 0.5° C. If the temperature difference ΔT is greater than the threshold value that indicates that the probe 100 has been installed in an improper, reverse orientation relative to the direction F of fluid flow 18.

If a reverse installation condition is determined, resister R2 is turned OFF at 168, and the control module 14 generates an alarm at 170, which can be communicated by the I/O module 16 to other device(s) and/or a user (e.g., audibly and/or visually) to convey the reverse installation condition of the probe 100. The improper installation of the probe 100 can, therefore, be corrected.

If, however, the temperature difference ΔT at 164 is less than the predetermined threshold value, that indicates that the probe 100 is installed in a proper orientation relative to the direction F of fluid flow. Thereafter, the resistor heater R2 is turned OFF at 166. Once the sensor 10 confirms the proper installation orientation of the probe 100, the sensor 10 can then be used to determine a fluid flow rate.

As mentioned above, it can be appreciated that the reverse-installation detection operating mode of the sensor 10 can also be used to determine whether there has been a change in the direction of flow of fluid through the probe 100. In this regard, as described above, the sensor 10 of the disclosure can determine whether the probe 100 has been properly installed relative to a known or expected direction of fluid flow. If, however, after proper installation of the probe 100 accordingly, the sensor 10 can employ the foregoing method to determine whether the direction of fluid flow has changed (e.g., reversed).

It can be further understood that the sensor 10 described in the present disclosure may also be incorporated into a multi-function sensor such as the sensor shown and described in U.S. Pat. No. 7,775,105, entitled “Multi-Function Sensor,” issued Aug. 17, 2010 and owned by Therm-O-Disc, Incorporated, the assignee of the present patent application, the disclosure of which is hereby incorporated by reference.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A fluid flow rate sensor comprising:
a probe comprising a detection module adapted to change condition in response to flow of a fluid through the probe, the detection module comprising:
means for detecting the flow rate of the fluid; and
means for detecting the installation orientation of the probe relative to the flow of fluid through the probe; and
a control module electrically connected to the probe, the control module monitoring the condition of the detection module and determining whether the installation orientation of the probe relative to the flow of fluid through the probe is reversed.

2. The fluid flow rate sensor of claim 1 wherein the detection module further comprises:
a printed circuit board;
wherein means for detecting the flow rate of the fluid comprises:
a first detection circuit disposed on a first side of the printed circuit board comprising first, second, third and fourth negative temperature coefficient thermistors arranged to form a 4-wire bridge such that the first and third thermistors form a first leg of the bridge and the second and fourth thermistors form a second leg of the bridge; and
a first heating circuit comprising a first resistor heater disposed on a second side of the printed circuit board generally opposite to the first and second thermistors of the 4-wire bridge;
wherein the means for detecting the installation orientation of the probe comprises:
a fifth negative temperature coefficient thermistor disposed on the second side of the printed circuit board; and
a second heating circuit comprising a second resistor heater disposed on the second side of the printed circuit board between the first resistor heater and the fifth negative temperature coefficient thermistor.

3. The fluid flow rate sensor of claim 2 wherein the probe further comprises a body, the body comprising:
a tubular member having a longitudinal axis and a passageway extending through the tubular member in a direction along the longitudinal axis; and
a housing made from a thermally conductive material disposed within the passageway;
wherein the detection module is received within the housing such that the means for detecting the flow rate of the fluid and the means for detecting the installation orientation of the probe lie within the passageway.

4. The fluid flow rate sensor of claim 1, further comprising an I/O module adapted to communicate an alarm indicating the reverse installation condition of the probe to another device or a user.

5. A fluid flow rate sensor comprising:
a probe comprising a passageway for accommodating a flow of fluid through the probe and a detection module adapted to change condition in response to the flow of fluid, the detection module housed in a thermally conductive material and disposed within the passageway;
the detection module comprising:
a first heating circuit;
a second heating circuit comprising a resistor heater;
a fluid flow rate detection circuit; and
a reverse-installation detection circuit having at least one negative temperature coefficient thermistor located in proximity to the resistor heater of the second heating circuit.

6. The fluid flow rate sensor of claim 5, further comprising a control module electrically connected to the probe, the control module monitoring the condition of the detection module and determining whether the installation orientation of the probe relative to the flow of fluid through the probe is reversed.

7. The fluid flow rate sensor of claim 6, further comprising an I/O module adapted to communicate an alarm for indicating a reverse installation condition of the probe to another device or a user.

8. The fluid flow sensor of claim 6, wherein the condition monitored by the control module is an output from the at least one negative temperature coefficient thermistor of the reverse-installation detection circuit.

9. The fluid flow sensor of claim 5 wherein the detection module further comprises:
a printed circuit board;
wherein the fluid flow rate detection circuit is disposed on a first side of the printed circuit board and comprises first, second, third and fourth negative temperature coefficient thermistors arranged to form a 4-wire bridge circuit such that the first and third thermistors form a first leg of the bridge circuit and the second and fourth thermistors form a second leg of the bridge circuit;
wherein the first heating circuit comprises a first resistor heater disposed on a second side of the printed circuit board generally opposite to the first and second thermistors of the 4-wire bridge circuit;
wherein the reverse-installation detection circuit comprises a fifth negative temperature coefficient thermistor disposed on the second side of the printed circuit board; and
wherein the second heating circuit comprises a second resistor heater disposed on the second side of the printed circuit board between the first resistor heater and the fifth negative temperature coefficient thermistor.

10. The fluid flow sensor of claim 9 wherein the fifth negative temperature coefficient thermistor is operable to detect heat generated by the second resistor heater when the probe is installed in a reverse orientation.

11. A method for determining the orientation of a probe with respect to the flow of a fluid, wherein the probe comprises a detection module comprising first, second, third and fourth temperature sensors arranged in a circuit, a first heater disposed in thermal communication with the first and second temperature sensors, a fifth temperature sensor, and a second heater disposed between the first heater and the fifth temperature sensor, the method comprising:
measuring a first temperature of the fifth temperature sensor;
turning ON the second heater;
measuring a second temperature of the fifth temperature sensor;
determining a difference between the second temperature and the first temperature;
comparing the difference between the second temperature and the first temperature with a threshold value;
if the difference between the second temperature and the first temperature is greater than the threshold value, then generating an alarm; and
turning OFF the second heater.

12. The method of claim 11 further comprising, before the step of measuring a first temperature of the fifth temperature sensor:
turning ON the first heater;
determining the flow rate the fluid;
comparing the flow rate of the fluid with a second threshold value; and
not proceeding to the step of measuring a first temperature of the fifth temperature sensor unless the flow rate of the fluid is greater than the second threshold value.
